(19) United States
(12) Patent Application Publication
(10) Pub. No.: US 2014/0366628 A1
(43) Pub. Date: Dec. 18, 2014

(54) VISUAL FLUID LEVEL INDICATOR

(71) Applicant: Caterpillar Inc., Peoria, IL (US)

(72) Inventors: Mark T. ALLOTT, Mapleton, IL (US); Joshua L. Seelye, Washington, IL (US)

(73) Assignee: Caterpillar Inc., Peoria, IL (US)

(21) Appl. No.: 14/253,298

(22) Filed: Apr. 15, 2014

Related U.S. Application Data
(60) Provisional application No. 61/834,259, filed on Jun. 12, 2013.

(51) Int. Cl. G01F 23/64

(52) U.S. Cl. CPC G01F 23/64
USPC 73/319

(57) ABSTRACT

A fluid level indicator is provided for use with a fuel system. The fluid level indicator may have a generally hollow body with an open first end and a closed second end configured to be mounted at least partially inside a filter canister. The fluid level indicator may also have an annular float configured to receive and slide along the second end of the generally hollow body, and a plunger located within an interior of the generally hollow body. At least one of the annular float and the plunger is magnetic and configured to interact with the other of the annular float and the plunger.

### RELATED APPLICATION

This application claims the benefit of priority under 35 U.S.C. §119(e) of U.S. Provisional Application No. 61/834,259, filed Jun. 12, 2013, the disclosure of which is incorporated herein by reference.

### TECHNICAL FIELD

The present disclosure is directed to an indicator and, more particularly, to a visual fluid level indicator.

### BACKGROUND

An engine combusts a mixture of fuel and air to generate mechanical power for different uses. In order for the engine to operate efficiently, the engine should be provided with fuel that is generally free of contaminates such as water. In some situations, however, it may be nearly impossible to keep contaminates out of the fuel. The contaminates can be introduced into an engine's fuel system when the system is not sealed. For example, humid air may enter a fuel tank when the tank is opened to be filled with fuel. The humid air can then condense on relatively cool internal walls of the tank, and the resulting water droplets can settle to the bottom of the tank. In addition, water can already be present in the fuel when the fuel is introduced into the tank. If the water is not removed from the tank, it can be drawn in the associated system by a pump and delivered to fuel injectors of the engine. This fuel could then cause the injectors to malfunction and/or negatively affect combustion within the engine's cylinders.

One way to accommodate water within a fuel system is to allow it to drain into the bottom portion of an inline filter, and periodically drain the water from the filter. The water can be drained from the filter on a regular basis or only when needed so as to save time and labor. It may be difficult to determine, however, when the filter needs to be drained (i.e., when a significant amount of water has been collected within the filter and should be removed).

One way to alert a service technician of the need to drain water from a fuel filter is disclosed in U.S. Pat. No. 6,012,485 that issued to Connely et al. on Jan. 11, 2000 (“the '485 patent”). Specifically, the '485 patent discloses a filter arrangement having a fluid level indicator connected to a fuel filter canister. The fluid level indicator includes a molded plastic float having a density that is greater than diesel fuel and less than water, such that the float sinks in the diesel fuel and floats in the water. The float is contained within a cage inside the filter canister, and includes a dark-colored elongated region extending from a bulbous-shaped portion. The elongated region is located within a tube-shaped window constructed of clear material and connected to the bottom of the fuel filter canister, such that the float is visible through the window. In operation, when the level of water within the canister is below the bulbous-shaped portion, the dark color of the elongated region is visible through the window. When the water level reaches the bulbous-shaped portion, the float starts to rise and float on the water. This causes the elongated region to no longer be visible through the window, thereby providing a visual indication to the service technician that it is time to drain the filter arrangement.

Although the fluid level indicator of the '485 patent may be adequate in some applications, it could be problematic in other applications. Specifically, it may be possible for the tube-shaped window to crack or break completely off. In this situation, fuel and water could spill from the window unchecked.

The disclosed fluid level indicator is directed to overcoming one or more of the problems set forth above and/or other problems of the prior art.

### SUMMARY

One aspect of the present disclosure is directed to a fluid level indicator. The fluid level indicator may include a generally hollow body with an open first end and a closed second end configured to be mounted at least partially inside a filter canister. The fluid level indicator may also include an annular float configured to receive and slide along the second end of the generally hollow body, and a plunger located within an interior of the generally hollow body. At least one of the annular float and the plunger is magnetic and configured to interact with the other of the annular float and the plunger.

Another aspect of the present disclosure is directed to a fluid filter assembly. The fluid filter assembly may include a generally hollow canister having an open first end and a closed second end, and a fluid level indicator located within the second end. The fluid level indicator may have a generally hollow body with an open first end, and a closed second end located at least partially inside the generally hollow canister. The fluid level indicator may also have a magnetic float configured to receive and slide along the second end of the generally hollow body, and a plunger located within an interior of the generally hollow body and configured to move with the magnetic float as the magnetic float slides along the second end. The fluid level indicator may further have a generally transparent window connected to the generally hollow body at the first end and configured to receive the plunger. The plunger may include an indicator end visible through the generally transparent window, and the fluid level indictor may additionally have a seal located between the first and second ends and around the generally hollow body. The seal may be configured to engage an end of the generally hollow canister.

In yet another aspect, the present disclosure is directed to a plunger for a fluid level indicator. The plunger may include a generally cylindrical stem configured to be received within a hollow interior of the fluid level indicator, and a magnetic head connected at a first end of the generally cylindrical stem. The plunger may further include a tip end having a visual appearance different from a visual appearance of the generally cylindrical stem and being connected at a second end opposite the first end. The plunger may also include a plurality of vertical ribs circumferentially spaced around the generally cylindrical stem, protruding radially outward, and extending from the magnetic head to the tip end.

### BRIEF DESCRIPTION OF THE DRAWINGS

FIG. 1 is a schematic illustration of an exemplary disclosed fuel system;

FIG. 2 is an isometric cutaway view illustration of an exemplary disclosed fluid filter assembly that may be used in conjunction with the fuel system of FIG. 1; and

FIG. 3 is a cross-sectional illustration of an exemplary disclosed fluid level indicator that may be used in conjunction with the fluid filter assembly of FIG. 2.

### DETAILED DESCRIPTION

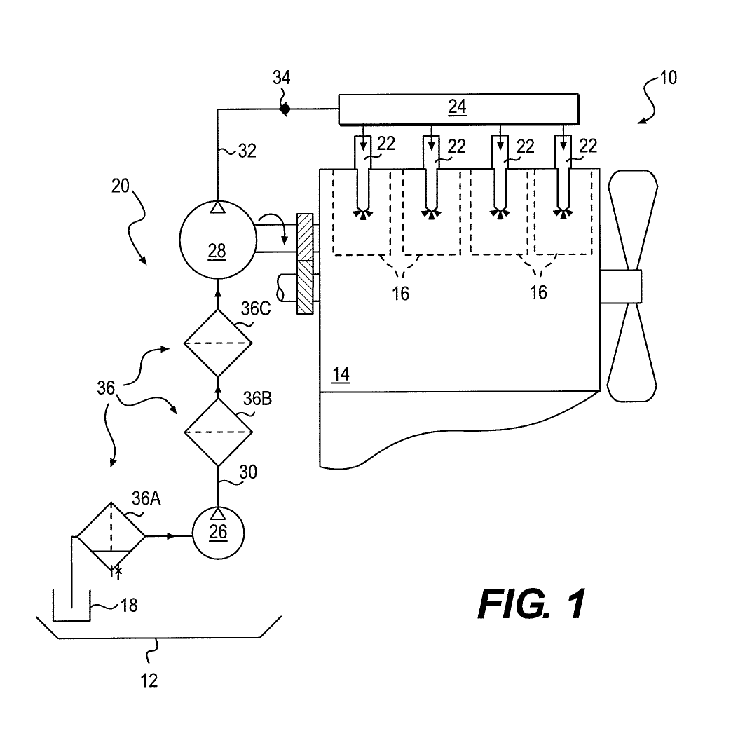

FIG. 1 illustrates an engine 10 equipped with an exemplary fuel system 12. For the purposes of this disclosure, engine 10 is depicted and described as a four-stroke diesel engine. One skilled in the art will recognize, however, that engine 10 may be any other type of internal combustion engine such as, for example, a gasoline or a gaseous fuel-powered engine. Engine 10 may include an engine block 14 that at least partially defines a plurality of combustion chambers 16. In the illustrated embodiment, engine 10 includes four combustion chambers 16. However, it is contemplated that engine 10 may include a greater or lesser number of combustion chambers 16 and that combustion chambers 16 may be disposed in an “in-line” configuration, a “V” configuration, or in any other suitable configuration.

Fuel system 12 may include components that cooperate to deliver injections of pressurized fuel into each combustion chamber 16 of engine 10. In one embodiment, fuel system 12 is a common rail type system. As such, fuel system 12 may include a tank 18 configured to hold a low-pressure supply of fuel, a fuel pumping arrangement 20 configured to pressurize the fuel and direct the pressurized fuel to one or more fuel injectors 22 by way of a manifold or common rail 24.

Fuel pumping arrangement 20 may include one or more pumping devices that function to increase the pressure of the fuel directed to common rail 24. In one example, fuel pumping arrangement 20 includes a low-pressure source 26 and a high-pressure source 28 disposed in series and fluidly connected by way of a fuel line 30. Low-pressure source 26 may be a transfer or feed pump configured to provide low-pressure feed to high-pressure source 28. High-pressure source 28 may be configured to receive the low-pressure feed and to increase the pressure of the fuel up to about 300 MPa or higher. High-pressure source 28 may be connected to common rail 24 by way of a fuel line 32. A check valve 34 may be disposed within fuel line 32, if desired, to provide for a unidirectional flow of fuel from fuel pumping arrangement 20 into common rail 24. One or more filters 36, such as a primary filter 36A, a secondary filter 36B, and/or a tertiary filter 36C may be disposed within fuel line 30 in series or parallel relation to remove debris, air, and/or water from the fuel pressurized by fuel pumping arrangement 20.

One or more of filters 36 may be different from the remaining filters 36. In particular, primary filter 36A may be configured to remove debris of a larger size, while secondary and/or tertiary filters 36B, 36C may be configured to remove debris of a smaller size. For example, primary filter 36A may be configured to remove debris that is about 10 μm or larger, while secondary and/or tertiary filters may be configured to remove debris that is about 4 μm or larger. In addition, primary filter 36A may be configured to separate a secondary fluid (e.g., water) from the primary fluid (i.e., the diesel fuel) passing therethrough. The secondary fluid may then be periodically removed from primary filter 36A.

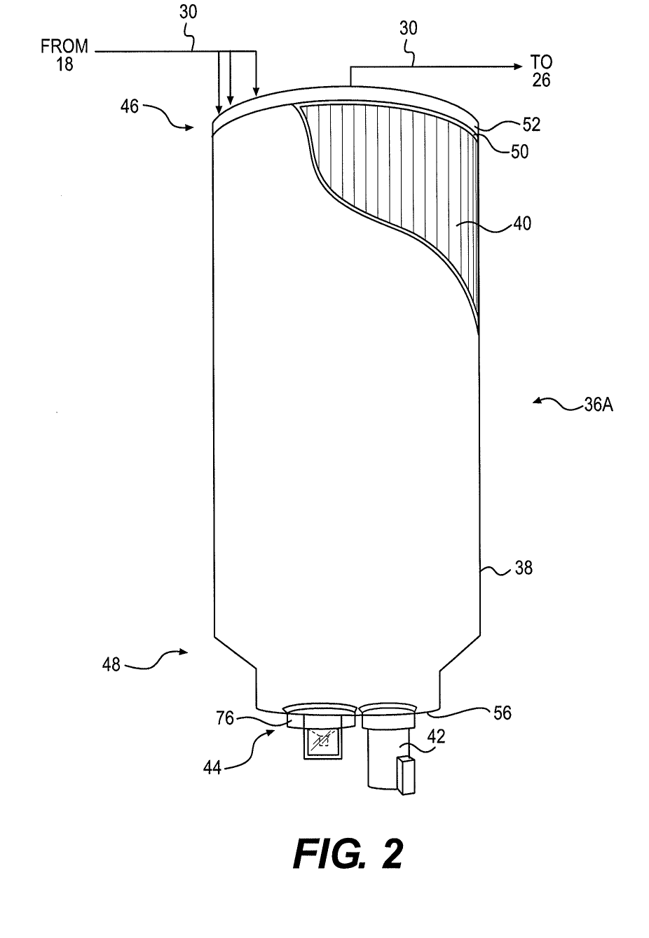

An exemplary embodiment of primary filter 36A is shown in FIG. 2. As shown in this figure, primary filter 36A may be an assembly of components that cooperate to remove debris and water from the fuel passing through fuel line 30. Specifically, primary filter 36A may include a canister 38, a filtration cartridge 40 disposed within canister 38, a valve 42 mounted at a bottom of canister 38, and a fluid level indicator (“indicator”) 44 mounted adjacent valve 42. Filtration cartridge 40 may be configured to continuously remove solid debris from the diesel fuel passing through primary filter 36A, while valve 42 may be used to manually remove water that has collected at a bottom of canister 38. As will be described in more detail below, indicator 44 may indicate when a significant amount of water has been collected within canister 38 and valve 42 should be opened.

Canister 38 may be a generally hollow housing having an open first end 46 and a closed second end 48. An adapter 50 may be provided at first end 46 that is configured to engage a mounting bracket (not shown) of engine 10, and a seal 52 may be located between adapter 50 and the bracket. In one embodiment, adapter 50 may have a centrally located bore (not shown) that is threaded and configured to receive a nipple of the mounting bracket, and a plurality of orifices spaced circumferentially-arranged around the nipple. With this configuration, fuel may be drawn by low-pressure source 26 into canister 38 via the orifices, through filtration cartridge 40, and out of canister 38 via the nipple (or alternatively in through the nipple and out through the orifices). Other means of connecting canister 38 to engine 10 may alternatively be used, if desired.

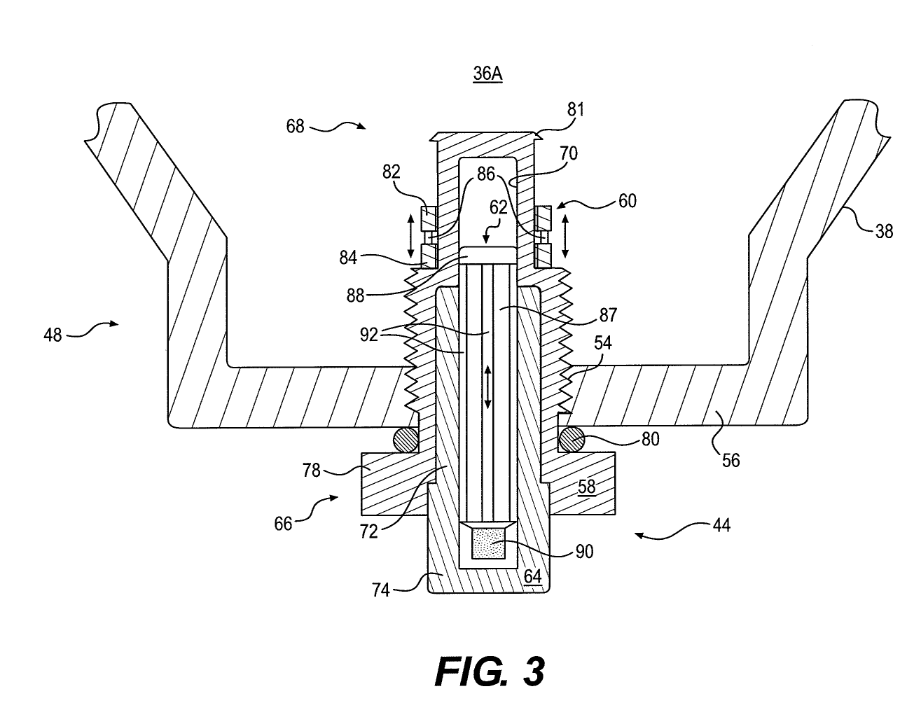

Second end 48 of canister 38 may be configured to receive valve 42 and indicator 44. In the disclosed example, second end 48 includes a threaded bore 54 for each of valve 42 and indicator 44 (only one threaded bore 54 shown in FIG. 3, in association with only indicator 44). Bores 54 may be centrally located within a lower-most portion of canister 38, for example within a generally flat end wall 56, and configured to engaged corresponding threaded features of valve 42 and indicator 44. It is contemplated, however, that valve 42 and/or indicator 44 could be connected to canister 38 in a manner other than threaded fastening, if desired. For example, valve 42 and/or indicator 44 could be integrally cast with, bonded to, or otherwise formed as a portion of canister 38.

Filtration cartridge 40 may be a conventional cartridge having a semi-permeable barrier selected to remove a desired amount of debris of a particular size from the fuel as it passes through primary filter 36A. For example, filtration cartridge could include a paper barrier that is pleated and/or wound to have a particular strength, porosity, particle retention, flow rate, and/or efficiency, depending on an intended application. Filtration cartridge 40 may be generally cylindrical, configured to fit inside of canister 38, and include a hollow core (not shown) that receives the mounting bracket nipple described above. Filtration cartridge 40 may be sealed against adapter 50 at first end 46 and against end wall 56 at second end 48, such that the only fluid path from the orifices described above to the nipple may be through the paper barrier.

Valve 42 may be a conventional valve having a valve element that is manually movable to selectively drain water from second end 48. For example, valve 42 may be a poppet type valve, a globe valve, a butterfly valve, a gate valve, or another type of valve known in the art. The valve element of valve 42 may be movable from a closed position to an open position when acted upon by a service technician (e.g., when pushed, pulled, twisted, etc.). In some embodiments, the valve element may be biased (e.g., spring-biased) toward the closed position.

As shown in FIG. 3, fluid level indicator 44 may be an assembly of components that together provide a visual indication as to when the valve element of valve 42 (omitted from FIG. 3 for clarity) should be moved to the open position (i.e., when a significant amount of water has collected at second end 48 of canister 38). Specifically, fluid level indicator 44 may include, among other things, a generally hollow body 58 configured to be mounted at least partially inside canister 38, an annular float 60 configured to receive and slide along an outside of body 58, a plunger 62 located within an interior of body 58 and configured to interact with float 60 through body 58, and a generally transparent window 64 connected to body 58 and configured to receive and enclose plunger 62. With this configuration, as will be described in more detail below, float 60 may move with the changing level of water inside canister 38, causing plunger 62 to move up and down within body 58 and become selectively visible through window 64, depending on the water level.

Body 58 may be a generally cylindrical member having an open first end 66 configured to receive plunger 62, and a closed second end 68 configured to be mounted within threaded bore 54 of canister 38. A stepped bore 70 may be formed within body 58 and include a smaller diameter at second end 68, a larger diameter at a midpoint between first and second ends 66, 68, and a largest diameter at first end 66. The smaller diameter may be configured to receive plunger 62 and allow plunger 62 to slide freely in an axial direction. The larger diameter may be configured to receive a main portion 72 of window 64, for example via an interference fit. The largest diameter may accommodate a head portion 74 of window 64. The outer surface of body 58 may likewise be stepped, and include a smaller diameter portion located within canister 38 and configured to be received within float 60, a larger diameter portion at the midpoint between first and second ends 66, 68 that has threads configured to engage bore 54 of canister 38, and a largest diameter portion protruding from end wall 56 of canister 38. One or more tool engagement features 76 (e.g., a hexagonal head configured to mate with a corresponding socket or end wrench—shown only in FIG. 2) may be located within a shoulder 78 at the largest diameter portion of body 58 and used to assemble indicator 44 into canister 38. Body 58 may be fabricated from a synthetic and non-magnetic material, such that body 58 does not impede the interaction between float 60 and plunger 62. A seal 80 may be disposed between first and second ends 66, 68 and around the larger diameter portion of body 58. Seal 78 may be configured to engage end wall 56 of canister 38 and be sandwiched between canister 38 and shoulder 78 during assembly.

In the disclosed embodiment of FIG. 3, a retention feature 81 is located at and slidingly connected to second end 68 of body 58. Retention feature 81 may be configured to retain float 60 in position. In one example, retention feature 81 may include a plurality of tapered protrusions extending radially outward from the second end of the generally hollow body. The taper of these protrusions may allow for float 60 to be pressed over second end 68, but inhibit reverse disengaging movement of float 60. It is contemplated that retention feature 81 may take a different form, if desired, and/or that retention feature 81 may be omitted from some embodiments.

Float 60 may be configured to cause movement of plunger 62 as float 60 slides along the outside of body 58 at the smaller diameter portion of second end 68. In one embodiment, float 60 is magnetic and interacts with an iron-based portion or all of plunger 62. In another embodiment, a portion of plunger 62 is magnetic and float 60 may be iron-based and configured to interact with that magnetic portion. In yet another embodiment, both of float 60 and plunger 62 include magnetic portions that are configured to interact with each other. In any of these embodiments, a raising or lowering movement of float 60 on the outside of body 58 may result in a corresponding raising or lowering movement of plunger 62 inside of body 58.

An exemplary arrangement of float 60 is shown in FIG. 3. In this arrangement, float 60 includes a first ring 82, a second ring 84 generally aligned with and spaced apart from first ring 82 in an axial direction, and a plurality of axial connecting members 86 disposed around a perimeter of first and second rings 82, 84 and connecting first and second rings 82, 84 to each other. One or both of first and second rings 84 may either be magnetic or configured to interact with a magnetic portion of plunger 62. The spaced apart nature of first and second rings 82, 84 may help to center float 60 on body 58, thereby inhibiting binding of float 60 and reducing a weight of float 60. It is contemplated that another configuration of float 60 may alternatively be utilized, if desired, such as a single and integral cylindrical structure. Regardless of the exact configuration of float 60, float 60 may have a density that allows it to float on water and sink in diesel fuel. Specifically, float 60 may have a density less than about 1,000 kg/m³ and greater than about 832 kg/m³.

Plunger 62 may be a composite of features configured to interact with body 58, float 60, and window 64. In particular, plunger 62 may include a generally cylindrical stem 87 that is configured to be received within the hollow interior of body 58 and window 64, and a head 88 connected at a first end of stem 87. In one embodiment, head 88 is magnetic and configured to attract float 60. In another embodiment, head 88 is not magnetic, but still iron-based and attracted to the magnetic portion(s) of float 60. Regardless of the configuration of head 88, stem 87 may be fabricated of the same or a different material, as desired. A tip end 90 of plunger 62 that is located opposite head 88 may have a visual appearance that is different from a visual appearance of stem 87. For example tip end 90 may be colored a different color (e.g., green), be fabricated from a different material, have a different surface texture, etc. Tip end 90 may be configured to extend into an exposed portion of window 64 when water levels within canister 38 are low and be retracted completely out of the exposed portion of window 64 when water levels are elevated. A plurality of vertical ribs 92 may be circumferentially spaced around stem 87, protrude radially outward, and extend from head 88 to tip end 90. Ribs 92 may help to strengthen plunger 62, while also helping to axially align plunger 62 within body 58 and thereby inhibit binding of plunger 62.

Window 64 may function as a cap that is configured to connect to and close off first end 66 of body 58. In the disclosed embodiment, main portion 72 may extend a distance into the larger-diameter of bore 70 and head portion 74 may extend into the largest diameter. In this embodiment, window 64 may have an axial length that is about equal to an axial length of plunger 62. Window 64 may be held in position via the press-fit of main portion 72 inside of bore 70, via threaded fastening (not shown) at head portion 74, and/or via chemical adhesion, as desired. It is also contemplated that, in some embodiments, main portion 72 may alternatively be omitted, if desired. In these alternative embodiments, bore 70 may have a smaller diameter at its midpoint such that plunger 62 may slide within and be guided solely by bore 70 instead of by window 64. Regardless of the configuration of window 64, some (e.g., only head portion 74) or all of window 64 may be at least partially transparent such that tip end 90 of plunger 62 may be visible through window 64 and thereby function as a visual indicator of water levels within canister 38.

### INDUSTRIAL APPLICABILITY

Although intended for use with a fuel system (e.g., a common rail fuel system), the disclosed fluid level indicator may have wide use in a variety of applications. For example, the disclosed fluid level indicator may have application in lubrication systems, hydraulic systems, transmission systems, and other fluid systems, where separation and removal of a secondary fluid from a primary fluid is desired. The disclosed fluid level indicator may provide a visual indication of an amount of secondary fluid (e.g., water) collected within an associated canister, allowing for a service technician to manually drain the secondary fluid from the canister. In addition, the disclosed fluid level indicator may reduce or even eliminate a likelihood of leakage caused by failure of the level indicator. Operation of fuel system 12 will now be described in detail, with particular attention to the functionality of fluid level indicator 44.

During operation of engine 10 (referring to Fig. I), low-pressure source 26 may draw fuel from tank 18 and transfer the fuel through filters 36 to high-pressure source 28. High-pressure source 28 may then increase the pressure of the fuel and direct the pressurized fuel to injectors 22 by way of common rail 24.

As the fuel from low-pressure source 26 passes through filtration cartridge 40 of primary filter 36A, water entrained within the fuel may be blocked by and/or adhere to the paper barrier therein. This water may then be pulled by gravity into a lower portion of canister 38 where it will collect at indicator 44. Once the water rises to a threshold level, float 60 of indicator 44 may begin to float on the water and be raised upward relative to body 58. As float 60 rises, plunger 62 may be pulled upward with float 60 by a magnetic interaction between these components. When water levels are low, tip end 90 may be visible within head portion 74 of window 64. However, as water levels continue to rise, plunger 62 may eventually be pulled to a height within window 64 where tip end 90 is no longer visible within head portion 74. When this happens, a service technician may be visually alerted of the need to drain water from canister 38. Accordingly, the service technician may open valve 42, draining the water and allowing float 60 and plunger 62 to return to their original positions.

Because plunger 62 may not be directly exposed to the fluids within canister 38, failure of indicator 44 (e.g., cracking or breaking of window 64) may not result in fluid spilling from primary filter 36A. This may allow for extended use of primary filter 36A in harsh applications that might otherwise preclude inclusion of indicator 44.

It will be apparent to those skilled in the art that various modifications and variations can be made to the fluid level indicator of the present disclosure without departing from the scope of the disclosure. Other embodiments will be apparent to those skilled in the art from consideration of the specification and practice of the fluid level indicator disclosed herein. It is intended that the specification and examples be considered as exemplary only, with a true scope being indicated by the following claims and their equivalents.

What is claimed is:

1. A fluid level indicator, comprising:
a generally hollow body having an open first end and a closed second end configured to be mounted at least partially inside a filter canister;
an annular float configured to receive and slide along the second end of the generally hollow body; and
a plunger located within an interior of the generally hollow body,
wherein at least one of the annular float and the plunger is magnetic and configured to interact with the other of the annular float and the plunger.

2. The fluid level indicator of claim 1, wherein the annular float is magnetic and configured to cause movement of the plunger as the float slides along the second end of the generally hollow body.

3. The fluid level indicator of claim 1, further including a generally transparent window connected to the generally hollow body at the first end and configured to receive the plunger.

4. The fluid level indicator of claim 3, wherein the plunger includes an indicator end visible through the generally transparent window.

5. The fluid level indicator of claim 4, wherein the indictor end has a color different from a remaining portion of the plunger.

6. The fluid level indicator of claim 3,.wherein the generally transparent window has an axial length about equal to an axial length of the plunger.

7. The fluid level indicator of claim 1, wherein the plunger includes:
a stem;
a cap located at one end of the stem; and
a plurality of ribs spaced apart around a periphery of the stem and extending in an axial direction of the stem.

8. The fluid level indicator of claim 7, wherein the cap is magnetic and configured to cause movement of the plunger as the annular float moves axially along the generally hollow body.

9. The fluid level indicator of claim 1, wherein the generally hollow body is fabricated from a synthetic non-magnetic material.

10. The fluid level indicator of claim 1, further including a seal located between the first and second ends and around the generally hollow body, the seal configured to engage an end of the filter canister.

11. The fluid level indicator of claim 10, wherein:
the generally hollow body further includes a shoulder located between the first and second ends that has tool engagement features; and
the seal is configured to be sandwiched between the end of the filter canister and the shoulder during assembly.

12. The fluid level indicator of claim 11, wherein the generally hollow body further includes external threads located between the tool engagement features and the second end, the external threads configured to engage internal threads of the filter canister.

13. The fluid level indicator of claim 1, wherein the annular float includes:
a first ring;
a second ring generally aligned with and spaced apart from the first ring in an axial direction; and
a plurality of connecting members disposed around a perimeter of the first and second rings and connecting the first and second rings.

14. The fluid level indicator of claim 1, further including a retention feature located at the second end of the generally hollow body that is configured to retain the annular float around connected to the generally hollow body.

15. The fluid level indicator of claim 14, wherein the retention feature includes a plurality of tapered protrusions extending radially outward from the second end of the generally hollow body.

16. The fluid level indicator of claim 1, wherein the annular float has a density greater than a density of a primary fluid passing through the filter canister and less than a secondary fluid entrained in the primary fluid.

17. The fluid level indicator of claim 16, wherein:
the primary fluid is diesel fuel; and
the secondary fluid is water.

18. A fluid filter assembly, comprising:
a generally hollow canister having an open first end and a closed second end; and
a fluid level indicator located within the second end, the fluid level indicator having:
a generally hollow body with an open first end and a closed second end located at least partially inside the generally hollow canister;
a magnetic float configured to receive and slide along the second end of the generally hollow body;
a plunger located within an interior of the generally hollow body and configured to move with the magnetic float as the magnetic float slides along the second end;
a generally transparent window connected to the generally hollow body at the first end and configured to receive the plunger, wherein the plunger includes an indicator end visible through the generally transparent window; and
a seal located between the first and second ends and around the generally hollow body, the seal configured to engage an end of the generally hollow canister.

19. The fluid filter assembly of claim 18, further including a valve located at the second end that is movable to selectively drain water from the generally hollow canister that separates from diesel fuel passing through the generally hollow canister, wherein the magnetic float has a density greater than diesel fuel and less than water.

20. A plunger for a fluid level indicator, comprising:
a generally cylindrical stem configured to be received within a hollow interior of the fluid level indicator;
a magnetic head connected at a first end of the generally cylindrical stem;
a tip end having a visual appearance different from a visual appearance of the generally cylindrical stem and being connected at a second end opposite the first end; and
a plurality of vertical ribs circumferentially spaced around the generally cylindrical stem, protruding radially outward, and extending from the magnetic head to the tip end.
